(19) United States
(12) Patent Application Publication
(10) Pub. No.: US 2005/0027564 A1
(43) Pub. Date: Feb. 3, 2005

(54) Term management system suitable for healthcare and other use

(76) Inventor: David Brook Yantis, West Chester, PA (US)

Correspondence Address: Alexander J. Burke;Intellectual Property Department, 5th Floor, 170 Wood Avenue South, Iselin, NJ, 08830, US

(21) Appl. No.: 10/865,617

(22) Filed: Jun. 10, 2004

Related U.S. Application Data
(60) Provisional application No. 60/479,603, filed on Jun. 18, 2003.

(51) Int. Cl. G06F 17/60; G06F 7/00; G06F 17/00

(52) U.S. Cl. 705/2; 707/104.1

(57) ABSTRACT

A system for use in managing data elements supporting operation of a multi-entity enterprise includes a first repository including a centralized set of enterprise related data elements. A first mapping processor converts a first data element compatible with a source system to a second data element compatible with the centralized set of enterprise related data elements. A second mapping processor converts the second data element to a third data element compatible with a destination system.

This is a non-provisional patent application of provisional application Ser. No. 60/479,603, filed by D. B. Yantis on Jun. 16, 2003.

### FIELD OF THE INVENTION

The present invention relates generally to the field of data processing, and more specifically to systems used in managing and exchanging data elements such as codes, terms and identifiers between disparate data processing systems and protocols, for example in a multi-entity enterprise.

### BACKGROUND OF THE INVENTION

The evolution of the data processing operations of any large business enterprise, and especially a multi-entity business enterprise, inevitably involves the acquisition of diverse systems used to support business operations. While it is necessary that data be exchanged between these different systems as part of the daily workflow, the actual integration of multiple systems is often difficult. Incompatible systems are often allowed or required to coexist, resulting in an array of systems that communicate with each other as affiliated rather than integrated entities. The sharing of data in such an inherently fragmented multi-entity enterprise is complicated by the fact that semantically identical data may represented by different data values in the different systems. In order to successfully integrate two separate systems, data from a first system is typically mapped to create data that is meaningful to a second system and visa versa. The existence of a third and fourth incompatible system further complicates such interfacing.

Prior systems provide mapping functions that convert or map data values from a first system to a second system. Under such scheme a system needs separate maps for the systems to which it is interlinked. The result is a plurality of dedicated maps which are capable of mapping data values from one particular system to another particular system. The creation of such dedicated “one-to-one” maps is time consuming and each individual map presents an opportunity for the introduction of errors. The data collected in such dedicated cross-mapping protocols is limited to interfacing two particular systems and is not useful in any mapping between any other two systems. Further, such data is not available to a system user to support other system operations. Other prior systems parse text documents and retrieve codes contained or implied by the text without mapping the terminology contained in the text, and without mapping the retrieved codes to a different set of codes.

An example of a real world multi-entity system is a large healthcare related enterprise that has expanded by acquiring smaller organizations that are geographically, operationally and technically diverse. Such an enterprise supplies services at a number of different locations which necessarily involve the participation and interaction of numerous employees, contractors and affiliates including clinics, institutions, physicians, pharmacies, other healthcare workers and hospitals. An interacting organization may also include multiple separate departments such as laboratory, radiology, pharmacy, surgery, emergency services and administration. Large quantities of information are gathered on a daily basis in order to support clinical care, patient tracking, billing and various administrative activities.

A need exists to collect information from numerous sources and locations and to share that information with the systems used by other entities. While the information being collected may contain different and inconsistent terminologies, vocabularies and identifiers, it is necessary that the shared data be consistently and accurately interpreted by each receiving party. Once the data is collected it should be consistently reusable in performing other tasks, and should ideally be available to authorized users of the system by means of a standard user interface.

### BRIEF SUMMARY OF THE INVENTION

In accordance with principles of the present invention, a system for use in managing data elements supporting operation of a multi-entity enterprise includes a first repository including a centralized set of enterprise related data elements. A first mapping processor converts a first data element compatible with a source system to a second data element compatible with the centralized set of enterprise related data elements. A second mapping processor converts the second data element to a third data element compatible with a destination system.

### BRIEF DESCRIPTION OF THE DRAWING

FIG. 1 shows a system for terminology management in the support of a multiple entity enterprise according to the principles of the present invention;

FIG. 2 depicts a user interface display image menu supporting administration of terminology maps created according to the principles of the present invention;

FIG. 3 shows a first example of a Term Value table containing a list of allowable values for each term created according to the principles of the present invention;

FIG. 4 depicts a user interface display image showing the relationship between Master Files, Terminologies, Terms and Maps;

FIG. 5 shows a user interface display image depicting a dialog from which Maps are associated according to the principles of the present invention;

FIG. 6 depicts a table listing terminologies that are defined within a system operating according to the principles of the present invention;

FIG. 7 shows a first example of a table depicting a set of terms used in each individual system operating within the present terminology management system;

FIG. 8 depicts a second example of a Term Value table containing a list of allowable values for each term used in a system operating according to the principles of the present invention;

FIG. 9 shows a first example of a Map table containing the names of maps created according to the principles of the present invention;

FIG. 10 depicts a first example of a Data Reference table constructed according to the principles of the present invention;

FIG. 11 shows a first example of a Vocabulary Map constructed according to the principles of the present invention;

FIG. 12 depicts a second example of a table listing terminologies that are defined within a system operating according to the principles of the present invention;

FIG. 13 shows a second example of a table depicting a set of terms used in each individual system operating within the present terminology management system;

FIG. 14 depicts a second example of a Vocabulary Map constructed according to the principles of the present invention;

FIG. 15 shows a second example of a Map table containing the names of maps created according to the principles of the present invention; and

FIG. 16 depicts a second example of a Data Reference table constructed according to the principles of the present invention.

### DETAILED DESCRIPTION OF THE INVENTION

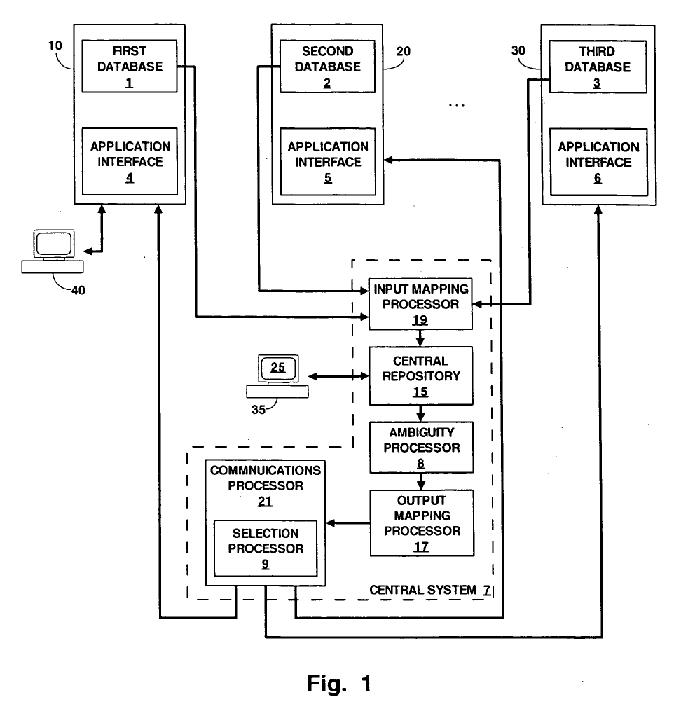

FIG. 1 depicts a multi-entity enterprise central server computer or system 7. The system 7 includes software applications that manage access and information flow among a plurality of client computers 10, 20 and 30. Central system 7 includes a central repository 15 for storing a database representing terminology in the form of data elements including code sets, terms and identifiers. The information contained within central repository 15 enables documentation, operation and interaction of entity-wide production-related, service-related and other business-related activities. The terminology contained within repository 15 is used to characterize and identify specific clients, entities, procedures, products, services and activities performed by or on behalf of the entities in the multi-entity business enterprise.

In the context of a multi-entity health care enterprise, the central repository 15 contains common or canonical terminology. The terminology in the central repository 15 includes medical terms, vocabularies and identifiers, as well as other healthcare related data elements useful in permitting physicians to treat patients having a medical condition. The healthcare related data elements include standard identifiers derived from either a national standard identifier set or an industry standard identifier set. Examples of the many available code sets include the Health Information Portability and Accountability Act (HIPAA) code, the International Classification of Disease (ICD) codes and the Health Care Financing Administration Common Procedures Coding System (HCPCS). The identifiers may identify, for example, a medical condition, a patient, a financial item, a billing item, a diagnostic code, a physician specialty, a treatment, a medicine or a service. A code set, as used in a medical context, may include any set of codes used in encoding data elements such as terms, medical concepts, medical diagnoses or medical procedures. The terms may be used to identify a health provider organization, a location within the organization, a healthcare worker, a medical condition, a health service, the cost of a medical service or procedure, a payer organization, a particular health plan or patient related information.

Each of the affiliated client computers 10, 20 and 30 also contains a database. For example, client computer 10 includes a first database 1 which contains information such as, for example, the aforementioned identification of a payer, health service and health plan information useful for facilitating the billing and financial operations involved in delivering healthcare to a patient. The information within first database 1 is structured and linked using known indexing and associative methods to facilitate access, information update and output communication to applications internal to the client computer 10 that request the information. A user of the first client computer 10 may access the first database 1 via a user interface 40, which may include a display device and associated input device, such as a keyboard and/or a mouse. The user interface 40 interacts with application interface 4 in order to provide access to information contained within the first database 1.

The second client computer 20 contains a second database 2 which contains information that may be similar in many respects to the information contained in first database 1. The type of information in second database 2 may be substantially identical to the information residing in first database 1, and may refer, for example, to exactly the same information, such as the name of a particular patient or physician, or to a particular medical condition or treatment protocol. However, the computer hardware and/or software implementing the client computer 20 may be different from that implementing the client computers 10. Thus, the particular manner in which similar or identical types of information are represented and stored in second database 2 may differ from the manner in which that same information is represented and stored in first database 1. Similarly, a third client computer 30 includes a third database 3 which also contains similar or substantially identical types of information, but which may be stored in a manner differing from the storage protocol or format of databases 1 and 2. Client computers 20 and 30 may also include user interfaces which are not germane to the present invention and are not shown to simplify the figure.

The information contained within first, second and third databases (1, 2 and 3), is represented by, and is internally structured and linked as, vocabulary objects, each vocabulary object having particular attributes. Vocabulary object attributes may include identifiers, healthcare provider organization data, business rules and synonyms. The identifiers may be used for the identification of healthcare workers, healthcare provider organizations, medical classifications, payer organizations, individual patients and similar information. The business rules may contain constraints associated with the vocabulary object. For example, rules associated with a particular physician may specify whether the physician is board certified and if the physician is limited to a particular specialty. Rules associated with a particular healthcare service may, for example, specify that a preauthorization or particular type of test or consultation occur prior to the performance of a given medical procedure.

Each of the client computers 10, 20 and 30 contains applications which may require information that does not reside within that client computer's own database. For example, the second client computer 20 may include applications requiring information contained within the first database 1 in first client computer 10. In the illustrated system, after being requested, the data is transferred from the first client computer 10 to the second client computer 20 in three steps. First, a message containing the requested data, represented by the values used in the first client computer 10, is sent to the central repository 15. In the central repository 15, the data values in the message are translated, or mapped, into the common or canonical values used for that data in the central repository 15 using a first map which translates data from values used in the first client computer 10 to values used in the central repository (and vice versa). A second map, which translates the required data from the values used in the central repository 15 to those used in the second client computer 20 (and vice versa), is then used to translate the values of the desired data from those used in the central repository 15 to those used in the second client computer 20. Then a corresponding message, containing the requested data represented by the values used by the second client computer 20, is assembled in the central repository 15 and sent to the second client computer 20. The second client computer 20 may then use the data in the received message, including presenting that data in a user interface on a display device. It is also possible that the destination system is the central computer system 7. In this case, only the input mapping is performed, and the received data may be displayed on the user interface 35.

In the central system 7, the input mapping processor 19 functions as a common master file vocabulary mapper that enables a central repository 15 to be maintained containing a common terminology for the differing terminologies and their respective term values in the client computers (10,20,30). Each of the source terminologies residing within the different databases 1, 2 and 3 may be mapped to the reference terminology within central repository 15 by the input mapping processor 19. The input mapping processor 19 may also insert a new term from a client computer (10,20,30) into the central repository 15 and change the map to properly map the new term. The input mapping processor 19 may also update a term in the central repository 15 and/or the map between a term in a client computer (10,20,30) and a term in the central repository 15. In this manner each of the potential mapping sets that would be required in transferring data from first database 1 to second database 2, second database 2 to first database 1, first database 1 to third database 3, etc., is advantageously reduced to a single centralized map set residing within the central repository 15.

In order to accomplish the mapping task, messages from the first client computer 10 containing data from the first database 1 (possibly intended to be transmitted to another client computer (20,30)) are forwarded to the input mapping processor 19 of the central server 7. The input mapping processor 19 executes a software component Vocabulary Mapper (VMap) that converts a first data element contained in a message received from first database 1 (or second database 2 or third database 3) to a second data element that is compatible with the data elements residing within the central repository 15. As described above, the databases 1, 2 and 3 may utilize different terminologies from each other and from the common vocabulary in the central server 7. The VMap program provides the means to convert data values received from one of the client computer system (10,20,30) to valid data values in the central system 7. The central repository 15 contains a centralized set of coded values that define a set of metadata, providing a one-to-many mapping of terminologies required by different, most likely incompatible, systems (10,20,30). The execution of the VMap program permits the mapping of data values to occur automatically during inbound message processing. The metadata that exists within central repository 15 exists separately from the application interfaces (4,5,6) and thus is available for reuse by various applications accessed by the central server 7.

More specifically, values representing data received from a client computer (10, 20, 30) are mapped by the input mapping processor 19 to values representing the same data according to the rules of the central terminology that resides within in the central repository 15. The output mapping processor 17 retrieves values for the same data from the central repository 15 and maps that data to values representing the same data compatible with the application interface 5 of the second client computer 20. That is, the output mapping processor 17 contains logic to convert the centralized terminology data sets from the central repository 15 into data elements usable by the application interface (4,5,6) in a specified destination client computer (10,20,30) without the need to create a dedicated cross map between the data contained within the source database, e.g. 1, and the destination database, e.g. 2. The output mapping processor 17 forwards the newly created data to a communications processor 21, which transmits the data in a message to the second client computer 20 as it is needed. The communications processor 21 also includes a selection processor 9 which assists the communications processor 21 in selecting the correct destination client computer 10, 20 or 30. The selection processor 9 contains logic for identifying information based on a predetermined protocol that associates particular data with a particular destination client computer.

Before the output mapping processor 17 receives data elements from the central data repository 15, the data contained within the central repository 15 is processed by an ambiguity processor 8. A data element requested by the output mapping processor 17 may be associated with more than one candidate data element in the central repository 15. In order to select the correct data element, ranking values are associated with the candidate elements. The ranking value is derived from a combination of values associated with factors such as: the time or date on which a record representing the candidate data element was stored, the identification of the particular user who stored the record, the location (for example, the client computer 10, 20, 30) from which the storage of the record was initiated, the probability of an error existing within the candidate data element, the source of the incoming message, the destination of the outgoing message, and so forth. One or more of these factors, as well as others, may be analyzed and weighted to establish a ranking value used as a criterion for selecting the correct data element. The candidate element with the highest ranking value is automatically selected and sent to the destination client computer (10,20,30). Alternatively, the selection of a particular data element can be chosen manually by a user via the user interfaces 35, 40.

As described above, a message received by the input mapping processor 19, instead of transmitting information from one client computer (10,20,30) to another, may instead specify a new record for, or an update to a record already in, the central repository 15. For example, the input message may contain information concerning physicians associated with a location of a constituent organization, a professional specialty of physicians associated with a constituent organization, medical services available to be provided by a particular physician at a location of the constituent organization, a cost associated with a medical procedure or service provided to a patient, a group of medical conditions associated with treatment provided at a location of the constituent organization, and so forth. The client computer at the location may update the central record in the central repository 15 in this manner.

The data values residing within the central repository 15 are also available for access and use in other applications in the central system 7 via the user interface 35. The user interface 35 permits access to display images 25 that are generated by the central server 7. The display images 25 permit the user to, for example, select a destination client computer (10,20,30) for data residing in the central repository 15, to permit data to be forwarded to a destination client computer in response to a request generated by that client computer, or to prohibit data transfer to a particular destination client computer.

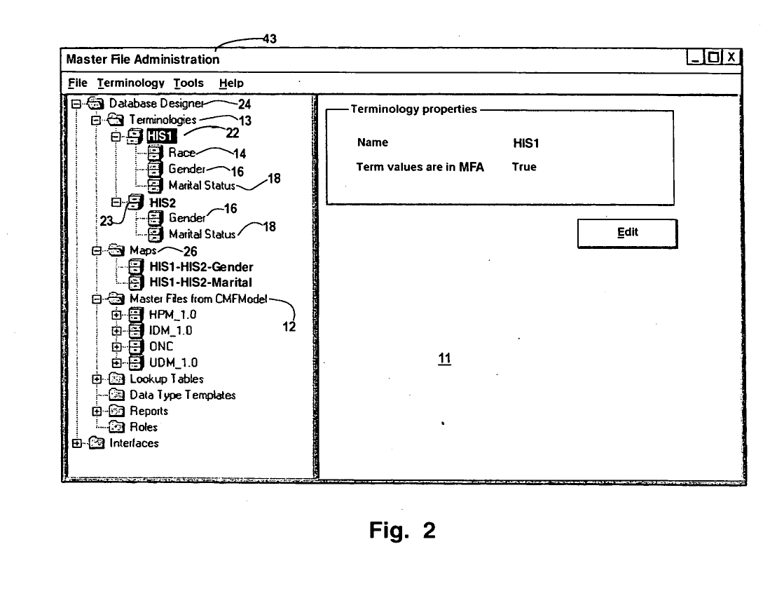

In order for the VMap program to create vocabulary maps, the terminologies and terms present in the central server 7 and the affiliated client computers 10, 20 and 30 are defined and maintained. As best seen in FIG. 2, vocabulary maps are created in an administration application 43, called “Master File Administration” (MFA), which includes a user interface image 11. Interface image 11 depicts the relationship between the master files 12, the terminologies 13, the terms 14, 16 and 18 in the terminologies 13, and the maps 26. In the example depicted in FIG. 2, two terminologies 22 (HIS1-Hospital Information System 1) and 23 (HIS2-Hospital Information System 2) are shown, each having, inter alia, terms 16 (Gender) and 18 (Marital Status) associated with, or defined within, each terminology. Image 11 also shows that maps 26 are defined as peers to terminologies 13 and master files 12. This relationship illustrates that maps 26 are available for use at various locations within the overall database designer application 24. The maps 26 are used for both inbound and outbound information transfers between the central server 7 and the affiliated client computers 10, 20 and 30, as described above.

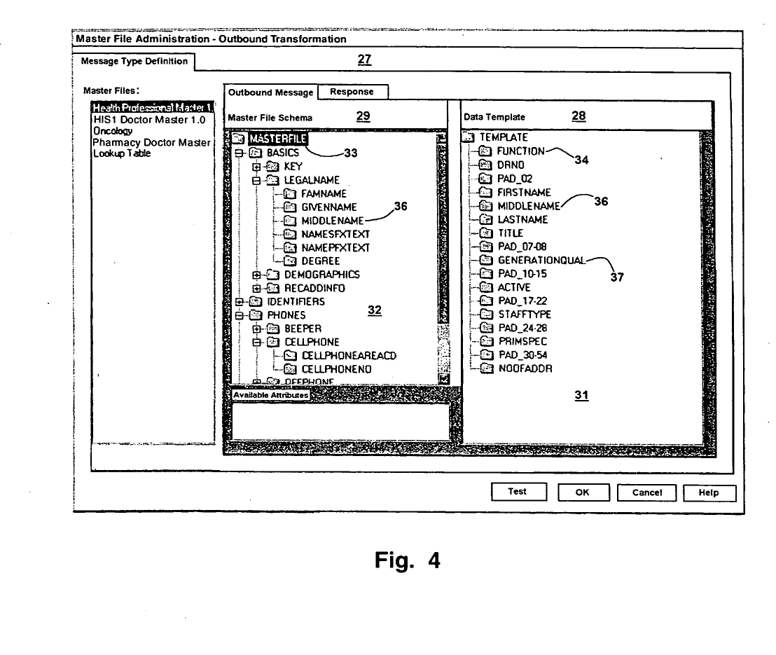

Referring to FIG. 4, an example of the processing of an outbound message can be better understood. The display image 27 depicts interface templates 28 and 29 used when converting or transforming an outbound message. The data template 28 defines the transaction layout or protocol 31 of the outgoing message data. The record template 29 defines the layout or protocol 32 of the master file 33 containing the canonical data which is to be translated into the data in the outgoing message. In the data template 28, each field or node 34, 36, 37, in the data template 28 representing the outgoing message, for example, can be associated with a term in the master file 33 as defined in a map 26 (FIG. 2).

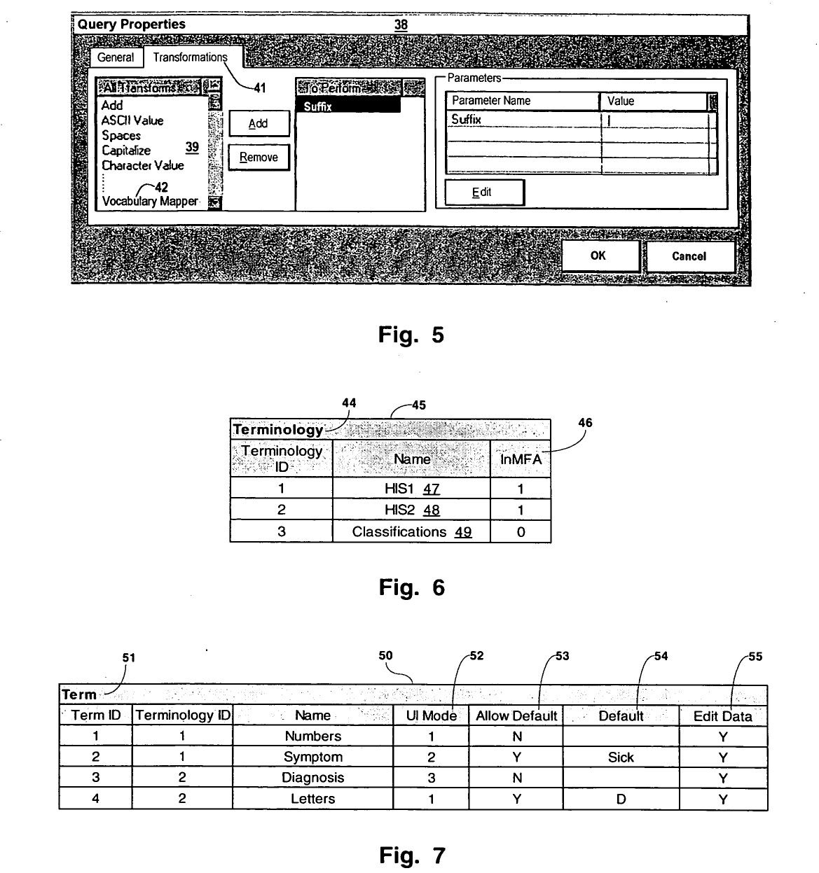

FIG. 5 illustrates a transformation dialog 38 used for associating maps 26 to a node. The transformation dialog 38 permits a user to select a desired transformation function. In particular, the list box 39, which lists all available transforms 41, including the vocabulary mapper transform 42. By selecting the vocabulary mapper transform 42 a user can gain access to the features of the vocabulary mapper (VMap).

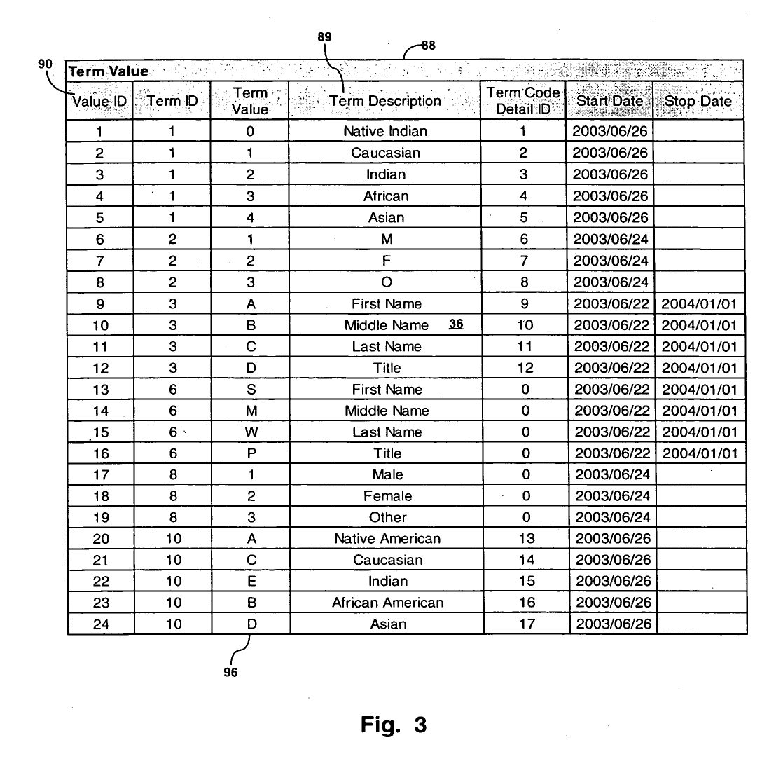

In order to support the VMap function, a number of tables are employed, of which there are examples illustrated in FIGS. 3, 6, 7, 8, 9, 10, 11, 12, 13, 14, 15 and 16. FIG. 6 depicts a terminology table 45 in which a list of terminologies are defined. A “terminology” 44 defines an endpoint for the transformation process of the present system. The first column lists a unique identification number for each terminology, and the second column lists a name. In column 46, the InMFA value indicates that the terminology is in the Master Files Administration application 43 (FIG. 2). That is, if column 46 is “1”, this indicates that the values for the terminology represented by that row, e.g. 47, exist in application 43, and hence are available for use as a center point in mapping, while if column 46 is “0”, this indicates that the values of terminologies represented by those rows, e.g. 48 and 49 are not present, i.e. they represent those terminologies which may be used in the client computers 10,20,30.

In the client computers 10, 20, 30 respective sets of terms are used. As seen in FIG. 7, a term table 50 is used to define terms 51 used within a particular client computer (10,20,30). Values cannot be assigned to a term unless the term is defined within a terminology (FIG. 6), and represented by an entry in the term table 50. In FIG. 7, each term is represented by a row in the term table 50 and identified by a unique term ID in the first column and by the ID of the terminology (FIG. 6) in which it appears in the second column. The name of the term appears in the third column. The UI (User Interface) mode column 52 indicates the manner in which data may be sent to the user interface 25 in the central system 7 (FIG. 1). A “1” appearing in column 52 indicates that there is no need to transfer a list of allowed data values to the user interface 25 and hence that there is to be no interaction with the user interface 25 for this term. A “2” appearing in column 52 indicates that allowed data values are to be sent to a selection control, such as a list box or dropdown list, in the user interface 25. A “3” appearing in column 52 indicates that data values are not to be initially sent to the user interface 25, but that the Ul 25 should indicate that allowed data values are available. In this case, when the user selects the appropriate control on the user interface 25, the central system 7 will execute a request to retrieve the allowed data values for the associated term and display or search those terms. The “allow default” column 53 and the “default value” column 54 indicate what should happen when no matching value for a particular term is found. In those cases where a default condition is permitted, the indicated default value is used. The “edit value” column 55 indicates if inbound message data should be edited based on a comparison with predetermined allowable values.

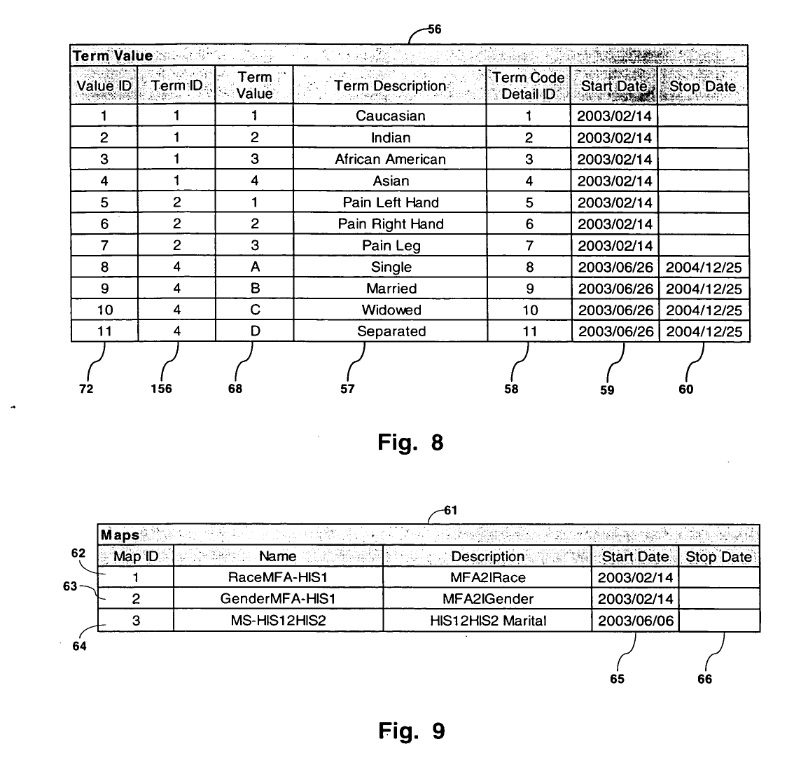

For the terms in the client computer systems 10, 20 and 30, as defined by entries in the table 50 (FIG. 7), there are respective sets of allowable values. FIG. 8 depicts a term value table 56 defining these allowable values. A row in the term value table 56 represents an allowed value for a term. A value in the term value table 56 is identified by a unique value identifier in column 72 and the by the term (FIG. 7) with which it is associated as indicated by the term ID in column 156. The allowable values for the terms are described in column 57. A start date and end date may be specified in columns 59 and 60, respectively for each term value. The value appearing in column 57 is typically not used unless the “start date” appearing in column 59 is equal to or earlier than the current date and the “stop date” appearing in column 60 is still in the future. The “Term Code Detail ID” column 58 refers to an entry in a term code detail table (not shown) that contains more information about the term value. The contents of the term code detail table may include notes for usage, details concerning the source of the data, details concerning projected usage dates and the expiration or useful life of the data.

For example, Term ID “1” represents a “Race” term. The values allowed for this term are defined in the first four rows of the term value table 56. The allowable values for the term “Race” are: “Caucasian”, “Indian”, “African American” and “Asian. Similarly, term ID “2” represents a “Symptom” term and the next three rows represent allowable values for that term: “Pain Left Hand”, “Pain Right Hand”, and “Pain Leg”. Term ID “4” represents a “Marital status” term and the next four rows represent allowable values for that term: “Single”, “Married”, “Widowed”, and “Separated”, and so forth.

Maps are used to perform the conversion of a term from the values used in one database to those used in a second database. As described above, a map bidirectionally converts data values from those used in databases in one of the client computers 10,20,30 to those used in the central repository 15 (FIG. 1). The map table 61 shown in FIG. 9 specifies the various maps 62, 63 and 64 that may be created when setting up the data transformation databases, and used during the data transformation process. Maps are identified by a unique map ID in the first column. The name for a map and a description are placed in the second and third column. A map is not active unless the start date appearing in column 65 is equal to or earlier than the current date while the stop date appearing in column 66 is still in the future. Maps can be created without being associated with a particular record template 29 or data template 28.

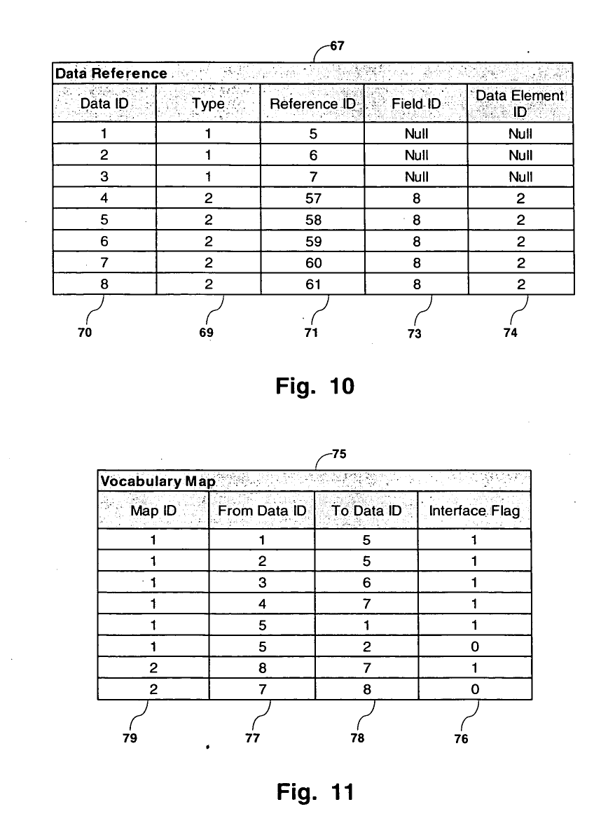

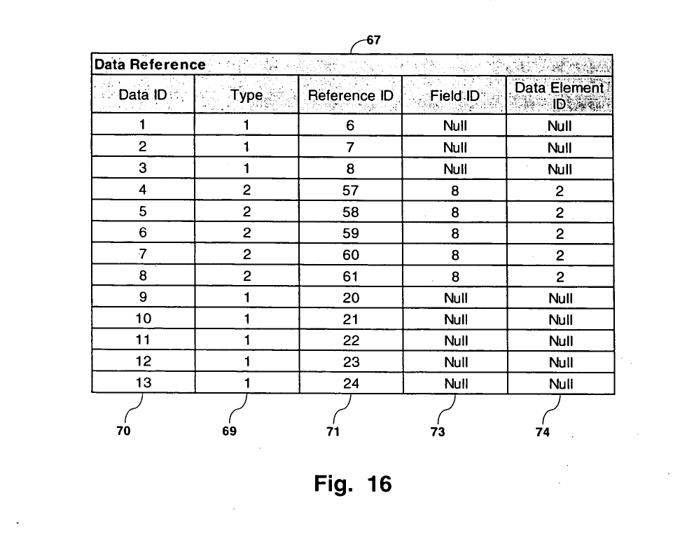

FIGS. 10 and 16 illustrate examples of data reference tables 67. The data reference table 67 provides a level of indirection to locate the data values to be used for comparison and mapping purposes by VMap. As described above, maps bidirectionally convert terms between values used in one of the client computers 10,20,30 and values used in the central repository 15 (FIG. 1). Thus, data values used in mapping may come from either the lists of allowable values in the term value table 56 (FIG. 8), representing the values in the client computers 10,20,30, or from the values stored in a master file 33 (FIG. 4) in the central repository 15 in the central computer 7 (FIG. 1). Each row in the data reference table 67 represents one data value and contains further information related to the location containing data representing that data value. The entries in the “Type” column 69 are used to indicate whether the “data ID” appearing in column 70 refers to an allowable value list (Type=1) or to a master file 33 (Type=2). The entry appearing in the “reference ID” column 71 contains either the “value ID” from column 72 of table 56 or an identifier of a meta-record in the master file 33 that contains the value. The entries in the “field ID” column 73 and the “data element ID” column 74 are null for Type=1. When master file values are represented, the “field ID” and “data element ID” values contain the identifications of the field of the meta-record that contains the data value.

The foregoing examples portray application specific data that are used to retrieve data from the meta-record. The more general use of the data reference table 67 (FIG. 10) is to provide a level of indirection between the vocabulary map table 75 depicted in FIG. 11 and the location of the data values, the data values being located in either the term value table 56 (FIG. 8) or in a master file 33 (FIG. 4). In FIG. 11, the vocabulary map 75 defines the conversion of values between one client computer system 10,20,30 to a different client computer system 10,20,30 based on one term per map. As described above, this conversion is performed in two steps. First, the data values received from the source client computer 10,20,30 are converted into common values in the central repository 15 (FIG. 1). Second the common values are converted into data values for the destination client computer 10,20.30.

In FIG. 11, a data value conversion is associated with a map (FIG. 9) by a Map ID value in column 79 specifying a row in the map table 61 (FIG. 9). Column 77 specifies a data ID value for a source data value in the data reference table 67 (FIG. 10) and column 78 specifies a data ID value for a destination data value in the data reference table 67 (FIG. 10). The interface flag column 76 indicates whether the vocabulary map 75 row is to be used by the input mapping processor 19 or the output mapping processor 17. A value of “1” in column 76 indicates that the map 75 is used by both the input 17 and the output 19 mapping processors. A value of “0” in column 76 indicates that the map 75 is used by the output mapping processor 19. A value appearing in the “From Data ID” column 77 may map to a multiplicity of values appearing in the “To Data ID” column 78, that is, there may be more than one row containing the same value in the “From Data ID” column 77. However, only one of those rows may have an interface flag value of “1”. Since no human intervention occurs during the conversion process, the interface flag value in column 76 serve as a tiebreaker to indicate which map is used by the input and output mapping processors 17 and 19. For example, in FIG. 11, two rows have the value “5” in the “From Data ID” column 77. Only the first row, having the value “1” in the “To Data ID” column 78, has a value “1” in the interface flag column 76. The second row, having the value “2” in the “To Data ID” column 78 has a value “0” in the interface flag column 76. This enforces the restriction that a term received from a source client computer 10,20,30 may map to a single term in the central repository 15, but that it is possible for more than one term in the central repository 15 to be mapped to a term in the destination client computer 10,20,30. Vocabulary maps 75 can also be used in situations in administrative application 43 where user intervention is expected. In those situations any ambiguous choices regarding the conversion of data values between systems 10 and 20 can be displayed to the user for an ultimate resolution.

A term that is part of the reference terminology in the central repository 15 (FIG. 1) may map to more than one value. In one embodiment of the present invention manual intervention, using the user interface 35, may be employed to resolve such an ambiguity. In a second embodiment of the invention, data values are shared automatically between the different systems 10, 20 and 30 without the need for manual intervention, requiring that any ambiguities be resolved by the ambiguity processor 8.

Referring again to FIG. 8, when a term conversion map 26 (FIG. 2) is defined between the reference terminology in the central repository 15 and a client computer system 10, 20 or 30, a value in column 68 is associated with each term 57 that is in the one-to-many relationship. The term value (col. 68) represents a weight that is based on one or more of a number of attributes or properties of the central system 7 including, for example, the time of day that the meta-record containing the term was saved, the identification of the user that saved the meta-record or the originating location of the meta-record save operation. Other attributes of the meta-record may also be used in an algorithm defined by the user. For example, if data element “A” appearing in the meta-record equals a certain value, such as “1”, then the weight assigned to element “A” can be increased by a user defined constant.

For example, a code may be included in a master file 12 (FIG. 2) that indicates the reason for changing the file. The change may e.g. either be “mandatory” or “optional”. Assuming that the particular master file 12 is entitled “Doctor Master”, it would typically include physician related information such as the name, physician specialty, address, associated hospitals and contact information. When this master file 12 is changed and a data value in this file is sent to an interested client computer system 10,20,30, the “reason for change” code is included. If the changed file data is initiated at a central office, the “reason” code may be listed as “mandatory”, while a similar change initiated at a field office might list he change in data as “optional”.

A second example involves a clerk who uses the central system 7 to initiate a work request intended for certain facilities. The work request in stored in the central system 7 and then forwarded to the client computer system 10,20,30 that manages that type of request. Requests that are entered into the system 7 outside of regular business hours generate a “request sent to” field that is mapped to an after hours support team, while requests that are entered during regular business hours have the “request sent to” field mapped to the core daytime support facility.

FIGS. 3, 12, 13, 14, 15 and 16 depict further examples of data tables as they might appear in an actual commercial environment. During outbound message processing, these tables are accessed for appropriate records and fields associated with a term. The first step performed by the central system 7 is to access the data template 28, representing the protocol of the outgoing message, shown in FIG. 4. For each term in the outgoing message, i.e. for each field 34, 36, 37, etc., appearing in the data template 28, the Vmap program performs several steps. In the following example, it is assumed that an outgoing message is being assembled to send to a client computer 10,20,30 using a “Patient Accounting” terminology.

The first step is to consult the query properties dialog 38 shown in FIG. 5 in order to determine the source of the data appearing in the record template 29 representing the contents of the master file. If the term is not associated with both templates 28 and 29, then no mapping is done, and only the regular data transformations 39 are performed.

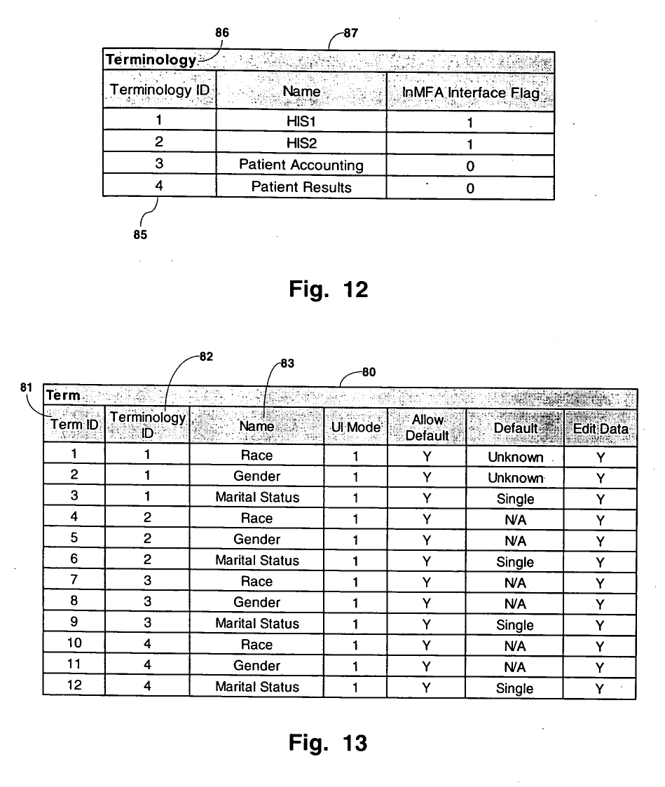

FIG. 13 shows a term table 80 containing a list of terms. The term ID column 81 assigns a unique ID number to each term. The terms appearing in column 83 are “race”, “gender” and “marital status”. These terms occur in four different terminologies, identified by their Terminology IDs in column. 82. FIG. 12 illustrates the terminology table 87 identifying the terminologies 86. Column 85 lists the unique identifier for each terminology. The ID number corresponding to the same terminology identifiers appear in column 82 of table 80 in FIG. 13.

The second step in outbound message processing occurs if a term occurs in both template references 28 and 29 (FIG. 4). For example, as seen in FIG. 4, the term 36 (MiddleName) appears in both templates. Referring now to FIG. 3, if a term does appear in both templates, the Vmap program accesses the term value table 88. The Vmap program searches column 89 of the term value table 88 for the term description matching that in the master file record identified by the record template 29, then selects the term value ID (column 90) for the row containing that term description. Continuing the example, the term 36 (MiddleName) appears in the term value table 88 in the row corresponding to a term value ID of “10”.

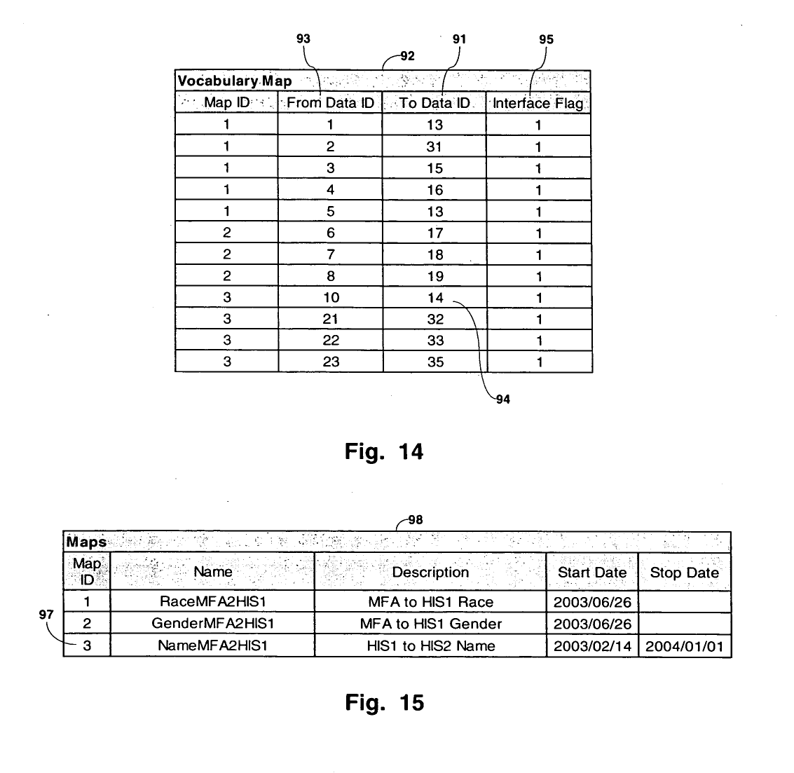

The third outbound message processing step is to access the vocabulary map table 92 as illustrated in FIG. 14. The Vmap program searches the “from data ID” column 93 to find the term value ID identified in the previous step, equal to “10” in the present example. The row containing that value is accessed to find the corresponding “to data ID” in column 91. The corresponding “to data ID” value (“14” in this case) to be selected appears in cell 94 of the “to data ID” column 91. Note that the interface flag of “1” appears in column 95, indicating the tiebreaker value used during automatic mapping.

The final step is to select the appropriate outgoing term value from the term value table 88 (FIG. 3). The term value ID, column 90, is searched to find the row containing the term value ID from the previous step. The correct outgoing mapped data value is found in column 96 in that row. In this case, the “to data ID” value is “14”, and the corresponding value in column 96 is “M”. The value of “M” will therefore be forwarded by the output mapping processor 19 (FIG. 1) to the communications processor 21. In some cases the transformation may need to be performed before and after the mapping process, with VMap functioning simply as a type of transformation. The map used during this transformation process of name data is identified in row 97 of the map table 98 (FIG. 15).

While the foregoing discussion uses outbound message processing as an illustrative example, inbound message processing also utilizes the tables just discussed for any field that is associated with a term. The mapped value is located from the vocabulary map. Once located, the mapped value is forwarded by the input mapping processor 19 to be applied to the master file 33 (FIG. 4).

The systems, processes and tables described above and illustrated in FIGS. 1-16 are not exclusive. The various tables illustrated are not intended to be a complete representation of any particular data transformation but only to illustrate the types of data manipulations that may occur according to the principles of the present invention. Other systems and processes may be derived in accordance with the principles of the present invention. The inventive principles disclosed herein may be used in a variety of environments and commercial settings for identifying and tracking service, location and organization related information and in supporting the executable applications of an organization requiring the use of common sets of codes, terms and identifiers. The inventive principles are not limited to the field of healthcare, but are instead applicable to any multiple system environments where different terminologies exist and operations are facilitated by having a common reference terminology.

1. A system for use in managing data elements supporting operation of a multi-entity enterprise, comprising:
a first repository including a centralized set of enterprise related data elements;
a first mapping processor for converting a first data element compatible with a source system to a second data element compatible with said centralized set of enterprise related data elements; and
a second mapping processor for converting said second data element to a third data element compatible with a destination system.

2. A system for use in managing healthcare related data elements including codes, terms and identifiers supporting operation of a healthcare enterprise, comprising:
a first repository including a centralized set of healthcare related data elements including codes, terms and identifiers;
a first mapping processor for converting a first data element in a received message to a second data element compatible with said centralized set of healthcare related data elements;
a second mapping processor for converting said second data element to a third data element compatible with a destination system; and
a communications processor for communicating a message including said third data element to said destination system.

3. A system according to claim 1 wherein said healthcare related data elements include standard identifiers derived from at least one of (a) a national standard identifier set and (b) an industry standard identifier set.

4. A system according to claim 1 wherein
said codes include at least one of (A) medical diagnosis codes and (B) medical procedure codes;
said terms are used for identifying at least one of (a) a health provider organization, (b) a location in an organization, (c) a healthcare worker, (d) a medical condition, (e) a Health service, (f) a cost of a medical procedure or service, (g) a payer organization, (h) a particular health plan and (i) patient related information; and
said identifiers are used for identifying at least one of, (i) a medical condition, (ii) a patient, (iii) a financial item, (iv) a billing item, (v) a diagnostic code, (vi) a physician specialty, (vii) a treatment, (viii) a medicine and (ix) a service.

5. A system according to claim 1 including an ambiguity processor for selecting said data element, to represent said first data element, from a plurality of candidate second data elements, in response to matching representative values associated with corresponding individual elements of said plurality of candidate second data elements.

6. A system according to claim 4 wherein an individual matching representative value is derived based on combining values associated with factors including at least one of (a) a time or date a record including said first data element was stored, (b) identification of a particular user storing said record, (c) a location where said storage of said record was initiated, (d) probability of error in said first term, (e) a source of said record and (f) a destination of said record.

7. A system according to claim 5 wherein said individual matching representative value is derived based on a weighted combination of said values.

8. A system according to claim 1 including an ambiguity processor for selecting said data element, to represent said first data element, from a plurality of candidate second data elements, in response to at least one of (a) a received selection command from a user and (b) automatic selection based on predetermined selection criteria.

9. A system according to claim 1 wherein said destination system comprises a system for incorporating said third data element data representative into a user interface for display to a user.

10. A system according to claim 1 wherein:
said first mapping processor converts a plurality of first data elements in a corresponding plurality of received messages to a plurality of corresponding second data elements compatible with said centralized set of healthcare related data elements,
said second mapping processor converts said plurality of said second data elements to a plurality of third data elements compatible with a corresponding plurality of different destination systems, and
said communications processor communicates a plurality of messages including said plurality of third data elements to said corresponding plurality of different destination systems.

11. A system according to claim 9 including a selection processor for selecting said plurality of different destination systems in response to predetermined information identifying usage of particular data elements by particular destination systems.

12. A system according to claim 1 including a display generator for initiating generation of data representing an image for display to a user, said image supporting user selection of at least one of (a) communication by said communications processor of said third data element to a destination system, (b) communication by said communications processor of said third data element to a destination system in response to a request from said destination system and (c) inhibition of communication by said communications processor of said third data element to a destination system.

13. A system according to claim 11 wherein said display comprises said destination system.

14. A system according to claim 1 wherein:
said received message identifies an update to a record in a file containing information concerning at least one of:
(a) physicians associated with a location of a constituent organization,
(b) a professional specialty of physicians associated with a constituent organization,
(c) medical services available to be provided by a particular physician at said location of said constituent organization,
(e) a cost associated with a medical procedure or service provided to a patient, and
(f) a plurality of medical conditions associated with treatment provided at a location of a constituent organization.

15. A system for use in managing healthcare related data elements including codes, terms and identifiers supporting operation of a healthcare enterprise, comprising:
a first repository including a centralized set of healthcare related data elements including codes, terms and identifiers;
a first mapping processor for converting a plurality of first data elements in a corresponding plurality of received messages to a plurality of corresponding second data elements compatible with said centralized set of healthcare related data elements; and
a second mapping processor for converting said plurality of second data elements to a plurality of third data elements compatible with a corresponding plurality of different destination systems, said different destination systems being selected in response to predetermined information identifying usage of particular data elements by particular destination systems.

16. A system according to claim 14 including a communication processor for communicating a plurality of messages including said plurality of third data elements to said corresponding plurality of different destination systems.

17. A system for use in managing healthcare related data elements including codes, terms and identifiers supporting operation of a healthcare enterprise, comprising:
a first repository including a centralized set of healthcare related data elements including codes, terms and identifiers;
a first mapping processor for selecting a second data element, to represent a first data element in a received message, from a plurality of candidate second data elements and for converting said first data element to said selected second data element to be compatible with said centralized set of healthcare related data elements; and
a second mapping processor for converting said second data element to a third data element compatible with a destination system.

18. A system according to claim 16 wherein said particular second data element is selected to represent said first data element in response to at least one of (a) a received selection command from a user and (b) automatic selection based on predetermined selection criteria.

19. A method for use in managing healthcare related data elements including codes, terms and identifiers supporting operation of a healthcare enterprise, comprising the activities of:
receiving a message including a first data element;
converting said first data element derived from said received message to a second data element compatible with a centralized set of healthcare related data elements including codes, terms and identifiers;
converting said second data element to a third data element compatible with a destination system; and
communicating a message including said third data element to said destination system.

20. A method for use in managing healthcare related data elements including codes, terms and identifiers supporting operation of a healthcare enterprise, comprising the activities of:
receiving a plurality of messages including a corresponding plurality of first data elements;
converting said plurality of said first data elements derived from said received message to a plurality of second data elements compatible with a centralized set of healthcare related data elements including codes, terms and identifiers; and
converting said plurality of said second data elements to a plurality of third data elements compatible with a corresponding plurality of different destination systems, said different destination systems being selected in response to predetermined information identifying usage of particular data elements by particular destination systems.

21. A method for use in managing healthcare related data elements including codes, terms and identifiers supporting operation of a healthcare enterprise, comprising the activities of:
selecting a second data element, to represent a first data element derived from a received message, from a plurality of candidate second data elements;
converting said first data element to said selected second data element to be compatible with a centralized set of healthcare related data elements including codes, terms and identifiers; and
converting said second data element to a third data element compatible with a destination system.
